(19) United States
(12) Patent Application Publication
(10) Pub. No.: US 2011/0204656 A1
(43) Pub. Date: Aug. 25, 2011

(54) Electronic Seal

(76) Inventor: Simon LAI, Banciao City (TW)

(21) Appl. No.: 12/360,143

(22) Filed: Jan. 27, 2009

(51) Int. Cl. E05B 47/00; E05C 19/00

(52) U.S. Cl. 292/2

(57) ABSTRACT

An electronic seal includes primarily a latch and a latch seat which can form lock-up. The latch and the latch seat are installed respectively with a radio-frequency chip and an antenna of a RFID system, as well as radio-frequency transmission lines allowing the radio-frequency chip and the antenna to be electrically connected, to provide an external reader-writer to access information inside the chip. A front end of the latch is provided with a first neck, and a second neck behind the first neck, allowing a C-shape snap ring in the latch seat to perform a second locking operation, such that when performing a first locking operation, the latch and the latch seat can be fastened together without escaping, and when performing the second locking operation, the radio-frequency chip and the antenna in the latch and the latch seat can be connected electrically.

### BACKGROUND OF THE INVENTION

a) Field of the Invention

The present invention relates to an electronic seal, and more particularly to a passive seal which combines a conventional bullet-type container lock with the RFID (Radio Frequency Identification) technology.

b) Description of the Prior Art

A conventional container seal is primarily used to avoid a risk that the container may be exchanged or stolen during shipping. However, that conventional seal needs to be identified by human eyes, which may result in failure of achieving expected functions inevitably by an human error or by being forged by other people. In terms of the existing manual transportation method, a customs officer needs to take a car to different customs areas for inspection, which not only increases administration cost but also delays customs clearance time of a company.

Therefore, an RFID electronic seal has been developed; this is a new seal combining the conventional container lock and the RFID technology. By using uniqueness and a feature of being hard to be forged of the RFID system, the risk that the container is exchanged is reduced. In addition, this electronic seal is installed with a radio-frequency chip that once the seal is locked, information on the radio-frequency chip will be accessed by a reader and transmitted to a back-end system. The electronic seal is further divided into a passive or an active type, depending on whether there is a power supply to the RF chip. An RFID unit which transmits RF (Radio Frequency) signals actively is referred to as an active tag, which can be read and written and can be used repeatedly. As being provided with an internal power source, the active tag can be applied broader than a passive tag chip and can monitor all the containers in a radius of 50 m (or even farther) of the reader that if they have been unlocked wrongfully; whereas, the back-end system can immediately find out that the containers have been damaged or intruded.

The existing conventional electronic seal is primarily constituted by a latch and a latch seat which form lock-up. The bullet-type container lock is built in with the RFID device, an interior of which is installed respectively with a radio-frequency chip and an antenna of the RFID system, as well as radio-frequency transmission lines allowing the radio-frequency chip and the antenna to be electrically connected that when the latch and the latch seat are joined and locked together, signals can be transmitted through radio frequencies. However, as the radio-frequency transmission lines in the latch and the latch seat usually adopt a concept of coaxial cable connector, that is, with one end being a male connector and the other end being a female connector; therefore, there is a concern that the transmission lines of the latch and the latch seat have already been in contact and conducted, when the latch has been inserted into the latch seat but the latch and the latch seat have not been accurately locked together yet. Accordingly, people with bad intention may take this chance to endanger safety of cargos and harbor businesses.

In view of an age of speed clearance of harbor freight and wireless communication, as well as an increasing amount of international freight, it is necessary to strictly control daily import and export. In order to facilitate freight transportation which is becoming complex and to speed up freight management, as well as to cope with an imminent request to safety of containers under a global anti-terrorism mood, computerization to the freight management in the harbor also demands immediate attention. Accordingly, if an electronic seal which is simple in structures and can assure zero-fault can be manufactured, then following positive benefits can be acquired:
1. Manpower and cost of a shipping company that increase during the manual transportation can be improved effectively.
2. The zero-fault electronic seal can be achieved.

Accordingly, how to design an electronic seal which is simple in structures, easy to operate and fits with a market demand is a technological issue to be solved by the present invention.

### SUMMARY OF THE INVENTION

Accordingly, the primary object of the present invention is to provide an electronic seal by which a trouble that after a latch of the electronic seal has been inserted into a latch seat but yet before reaching to a sealed point, radio-frequency transmission lines of the latch and the latch seat have already been in contact to conduct a radio-frequency transmission line of an RFID system, can be avoided.

The present invention provides a first neck on the latch for fastening with a C-shape snap ring in the latch seat. A rear end of the first neck is added with a second neck. When the latch is extending into the latch seat, the first neck passes through the C-shape snap ring in the latch seat. At this time, the radio-frequency transmission lines of the latch and the latch seat have not been in contact yet, and the radio-frequency transmission line of the RFID system has not been conducted, either. Nevertheless, the latch has not been able to escape successfully from the latch seat already. When the latch is further extending into the latch seat, the radio-frequency transmission line of the RFID system can be conducted, and the second neck of the latch is fastened with the C-shape snap ring in the latch seat, thereby accomplishing a sealing operation of the electronic seal.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of structures of the present invention.

FIG. 2 shows a schematic view of a first locking operation of a latch and a latch seat, according to the present invention.

FIG. 3 shows a schematic view of a second locking operation of a latch and a latch seat, according to the present invention.

### DETAILED DESCRIPTION OF THE PREFERRED EMBODIMENTS

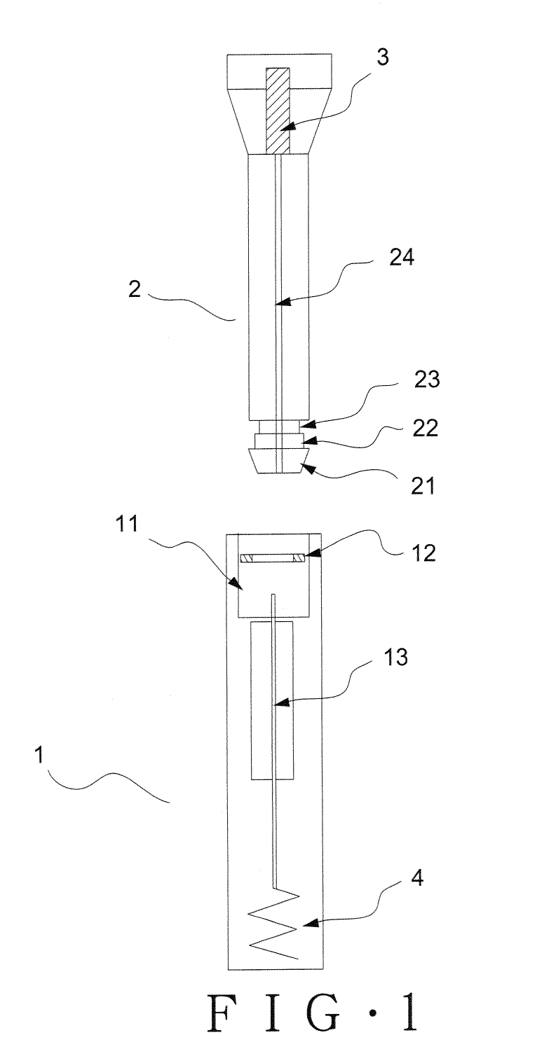

Referring to FIG. 1, which shows a schematic view of structures of the present invention, in reference with all other drawings, the present invention comprises primarily a lock part, a radio-frequency chip 3 and an antenna 4 which are built into the lock part. The lock part is constituted by a latch seat 1 and a latch 2 which can be joined together to form a lock-up state. An end of the latch seat 1 is provided with a connection member 11 to join with the latch 2, an inner rim of the connection member 11 is embedded with a metallic C-shape snap ring 12, and an interior of the latch seat 1 is configured with the antenna 4 and a radio-frequency transmission line 13 for signal connection. An end of the latch 2 is formed with a cone-shape plug 21, a rear end of the plug 21 is provided with a first neck 22, behind which is a second neck 23; wherein, a diameter of the plug 21 is larger than that of the first neck 22, and the diameter of the first neck 22 is in turn larger than that of the second neck 23, allowing the C-shape snap ring 12 in the latch seat 1 to perform a second locking operation. The other end of the latch 2 is embedded with the radio-frequency chip 3 and a circuit of the radio-frequency chip 3, an interior of the latch 2 is configured with the radio-frequency chip 3 and a radio-frequency transmission line 24 for signal connection.

The RFID system is constituted by the radio-frequency chip 3 and the antenna 4 which are provided respectively in the aforementioned latch 2 and the latch seat 1; whereas, signal transmission between the radio-frequency chip 3 and the antenna 4 is through the radio-frequency transmission lines 13, 24 in the latch 2 and the latch seat 1 to achieve a radio frequency function, with the radio-frequency transmission lines 13, 24 being coaxial cables.

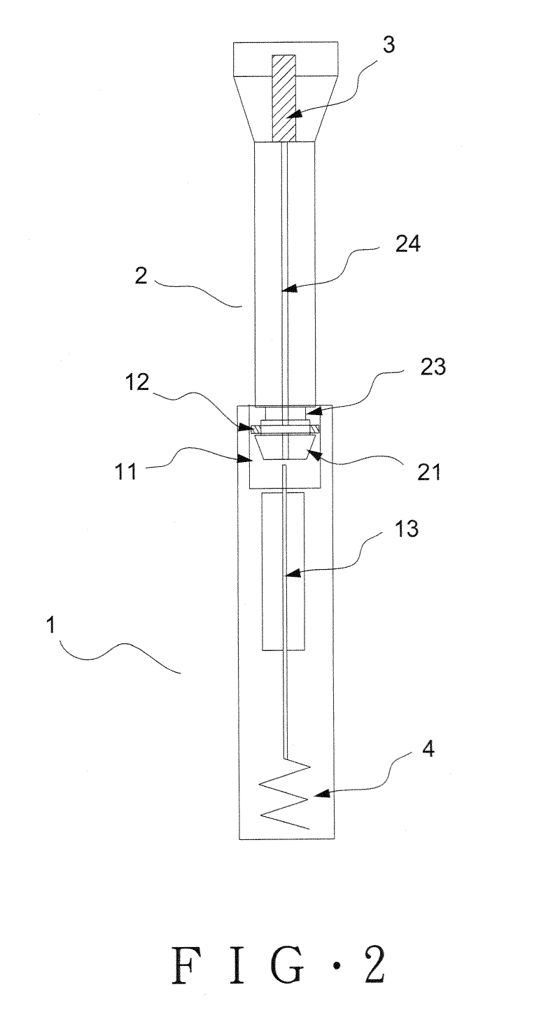

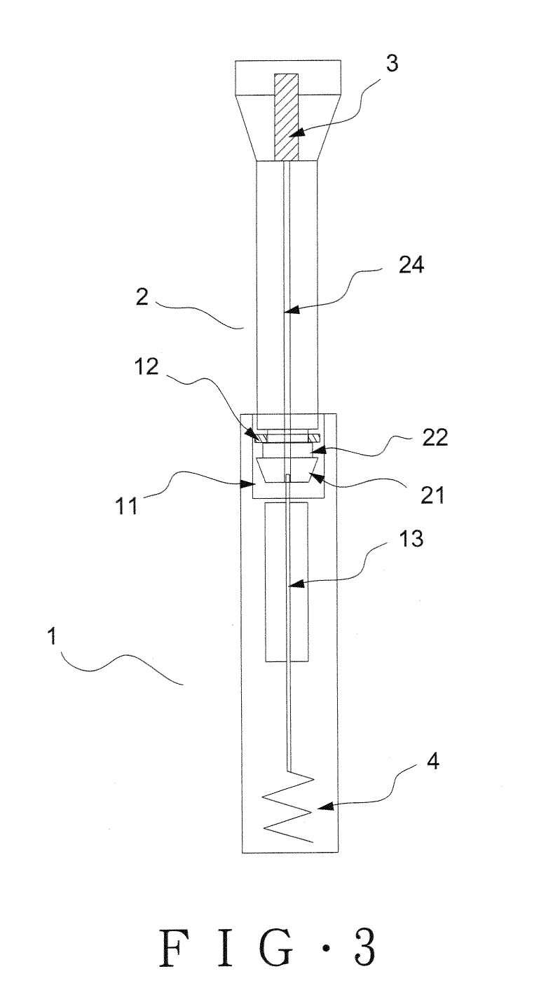

When the latch 2 is inserted into the latch seat 1 (as shown in FIG. 2), the plug 21 at the front end of the latch 2 is forced into the connection member 11 on the latch seat 1. When the latch 2 is extending into the latch seat 1, the C-shape snap ring 12 is stretched larger gradually by the insertion of the cone-shape plug 21, and finally falls on the first neck 22 of the latch 2. At this time, the C-shape snap ring 12 is shrunk inward due to elastic force of the metal, and as the diameter of the first neck 22 of the latch 2 is smaller than that of a tail rim of the plug 21, the latch 2 is restricted inside the C-shape snap ring 12 of the latch seat 1 and cannot escape successfully from the latch seat 1. At this time, the radio-frequency transmission lines 13, 24 of the latch 2 and the latch seat 1 have not been in contact yet, and the RFID system cannot develop functions, either. When the latch 2 continues to extend into the latch seat 1, the C-shape snap ring 12 of the latch seat 1 slides from the first neck 22 to the second neck 23 (as shown in FIG. 3), and is further shrunk inward by the elastic force of the metal. As the diameter of the second neck 23 is smaller than that of the first neck 22, the latch 2 cannot escape successfully from the latch seat 1. At the same time, the radio-frequency transmission lines 13, 24 of the latch 2 and the latch seat 1 are exactly connected with each other, allowing the radio-frequency chip 3 in the latch 2 and the antenna 4 in the latch seat 1 to produce the radio frequency function. Therefore, information (such as number of goods, data, etc.) on the radio-frequency chip 3 can be accessed by a reader and transmitted to a back-end system for monitoring. If the lock part is unlocked by being damaged by any method, allowing the latch 2 to be pulled out of the latch seat 1, then, at this time, the signal transmission between the radio-frequency chip 3 in the latch 2 and the antenna 4 in the latch seat 1 is interrupted as the radio-frequency transmission lines 13, 24 cannot be connected electrically, resulting in that the radio-frequency chip 3 cannot operate to lose the RFID function, in turn.

The most important feature of the present invention lies in that the latch 2 is configured with the first neck 22 and the second neck 23 behind the first neck 22, to form a two-stage locking operation. In the first stage of locking operation, the latch 2 has not been able to escape from the latch seat 1 already, but the radio-frequency transmission lines 13, 24 of the two have not been connected yet; therefore, the RFID system cannot develop the functions, either. In the second stage of locking operation, the radio-frequency transmission lines 13, 24 of the two are connected electrically, thereby assuring the zero-fault effect that when the electronic seal is not locked completely, the RFID system will not be able to develop the functions.

By the aforementioned technologies, the electronic seal accomplished is simple in structures, can effectively improve the increase of manpower and cost of a shipping company during manual transportation, and can avoid a concern that when the prior art is not locked, the RFID function is activated to allow people with bad intention to take that chance to endanger safety of cargos and harbor businesses.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. An electronic seal comprising a lock part which is assembled by a latch and a latch seat to form lock-up, with the latch seat being provided with a connection member to join with a plug on the latch; and an RFID (Radio Frequency Identification) system which is constituted by a radio-frequency chip, an antenna and radio-frequency transmission lines linking the radio-frequency chip with the antenna to form electric connection, with the radio-frequency transmission lines being embedded respectively in the latch seat and the latch, providing an external reader-writer to access information in the chip; wherein, a front end of the latch being provided with a first neck and a second neck behind the first neck, allowing a C-shape snap ring in the latch seat to perform a second locking operation; a diameter of the first neck being larger than that of the second neck, such that when performing a first locking operation, the latch is fastened with the latch seat without escaping, and when performing the second locking operation, the radio-frequency chip and the antenna in the latch and the latch seat are connected electrically.

2. The electronic seal according to claim 1, wherein a front end of the latch is in a cone shape.

3. The electronic seal according to claim 1 wherein the radio-frequency transmission line is a coaxial cable.
